(19) United States
(12) Patent Application Publication
(10) Pub. No.: US 2009/0268074 A1
(43) Pub. Date: Oct. 29, 2009

(54) IMAGING APPARATUS AND IMAGING METHOD

(75) Inventor: Youichi Sugino, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/397,845

(22) Filed: Mar. 4, 2009

(30) Foreign Application Priority Data
Mar. 7, 2008 (JP) 2008-058280

(51) Int. Cl. G06T 7/00; H04N 5/222

(52) U.S. Cl. 348/333.02; 382/103; 348/E05.022

(57) ABSTRACT

An imaging apparatus capable of reducing the possibility that shooting images fails, by preventing a subject from going out of the frame, being occluded and being recognized erroneously, and improving the usability of the tracking function. With this imaging apparatus, display information creating section 107 creates display information which calls for attention not to lose the sight of main subject 300 that is being tracked or not to make main subject 300 go out of the frame, and associates the created display information with main subject 300 that is being tracked to display on display screen 200.

### CROSS REFERENCE TO RELATED APPLICATIONS

The disclosure of Japanese Patent Application No. 2008-058280, filed on Mar. 7, 2008, including the specification, drawings and abstract, is incorporated herein by reference in its entirety.

### BACKGROUND

1. Technical Field

The technical field relates to an imaging apparatus and imaging method for shooting an optical image of a subject. To be more specific, the present invention relates to an imaging apparatus with a subject recognition function and tracking function, and an imaging method.

2. Description of the Related Art

Conventionally, a technique is known for finding data of features of a main subject and estimating an area where the main subject is present in video data based on the data of features. Particularly, processing of sequentially finding the area in which the main subject is present in video image data that is inputted sequentially, is carried out so as to track the moving main subject, and, therefore, is frequently referred to as “tracking processing” or “chasing processing.”

Various imaging apparatuses are proposed for applying such tracking processing to such as auto focus, exposure control and framing control for adjusting the shooting range. See, for example, Patent Document 1 (Japanese Patent Application Laid-Open No. HEI7-143389).

Patent Document 2 (Japanese Patent Application Laid-Open No. 2005-341449) discloses an imaging apparatus with a monitor that tracks a designated subject and displays in which location on the display screen of the monitor the tracking subject is located.

FIG. 1 shows an example of a display screen of a digital still camera mounting a tracking function disclosed in Patent Document 2. In FIG. 1, the digital still camera specifies the location of image 10 of the subject that is designated as a tracking target, on display screen 20 from image data acquired as a result of shooting an image and displays arrow 30 or a frame which points at the specified location on display screen 20. In this way, the location of the tracking target is pointed at by drawing an arrow or frame in image data, so that it is possible to prevent the user of the video camera or camcorder from losing the sight of the main subject.

Patent Document 3 (Japanese Patent Application Laid-Open No. 2007-129480) discloses an imaging apparatus that displays on the display screen the direction in which the imaging apparatus must be moved to prevent the face of the main subject from going out (i.e. frame-out) of the shooting range. Patent Document 3 also discloses a function of predicting to which location the main subject has moved, after a certain period of time using history of the face detection result and displaying the location.

However, such conventional imaging apparatuses mounting tracking function have the following problems.

The digital still camera disclosed in Patent Document 1 points at the location of the main subject of the tracking target, yet gives no thought to the presentation of various items of information which are required when considering for the user not to lose the sight of the main subject, such as the moving speed or moving direction of the main subject.

Further, there are a number of cases other than cases of frame-out where the user loses the sight of the main subject. However, a display for avoiding such cases has not been taken into account both in the digital still camera disclosed in Patent Document 2 and the imaging apparatus disclosed in Patent Document 3. For example, in cases where the main subject hides behind other objects and cannot be seen (i.e. occlusion) or in cases where the tracking object moves so far that tracking processing cannot maintain satisfying accuracy, preferably, the user can know possibilities of these cases in advance. This is because, in such cases, cases may occur where due to termination or failure of tracking processing, control processing that Falls short of user's expectations, such as that focus is adjusted upon an object other than the main subject, inappropriate exposure control is carried out, or framing is set neglecting the main subject, is carried out and, as a result, shooting images fails. Further, when tracking processing is used to display the location of the main subject, cases may occur where the user suddenly loses the sight of the main subject or erroneously recognizes an object or person similar to the main subject as a main subject and, therefore, a problem of shooting an undesirable range of an image occurs.

### SUMMARY

The object is to provide an imaging apparatus and imaging method for reducing the possibility that the user loses the sight of the subject due to frame-out of the subject and for improving the usability of the tracking function.

An imaging apparatus employs a configuration including: an imaging optical system that forms an optical image of a subject; an imaging section that converts the optical image into an electrical signal; a signal processing section that carries out predetermined processing of the electrical signal to generate image data; a display section that displays the generated image data on a display screen; a tracking section that tracks the subject which is designated at random, based on the generated image data; a display information creating section that creates display Information showing a state of the subject that is being tracked, based on at least one of a motion of the subject that is being tracked in the display screen and a location of the subject that is being tracked in the display screen; and a controlling section that displays the created display information in the display section.

An imaging method in an imaging apparatus includes: tracking a subject that is designated at random from image data shot by the imaging apparatus; creating display information showing a state of the subject that is being tracked, based on at least one of a motion of the subject that is being tracked in a predetermined display screen and a location of the subject that is being tracked in the display screen; and displaying the created display information.

The imaging apparatus and imaging method present information showing the state of tracking processing, so that it is possible to readily prevent the subject from going out of the frame, being occluded or being erroneously recognized, reduce the possibility that shooting images fails and improve the usability of the tracking function.

### BRIEF DESCRIPTION OF THE DRAWINGS

FIG. 1 shows an example of a screen display of a conventional digital still camera mounting a tracking function;

FIG. 2 is a block diagram showing a configuration of an imaging apparatus according to an embodiment of the present invention;

FIG. 3A shows content of tracking processing result information acquired in a tracking processing section of the imaging apparatus according to the present embodiment;

FIG. 3B shows content of tracking processing result history acquired in the tracking processing section of the imaging apparatus according to the present embodiment;

FIG. 4 shows a display example of a display section of the imaging apparatus according to the present embodiment in a recording stand-by mode upon tracking shooting mode;

FIG. 5 is a flowchart showing steps of display information creation processing in a display information creating section of the imaging apparatus according to the present embodiment;

FIG. 6 shows a display example of a motion vector of a main subject of a tracking target, in the imaging apparatus according to the present embodiment;

FIG. 7 shows a display example in the imaging apparatus according to the present embodiment applying the motion vector of the main subject to a display for frame-out prevention;

FIG. 8A shows a display example in the imaging apparatus according to the present embodiment where display content changes depending on how far the main subject moves from the center of the video image, and shows an example where the main subject moves from the center of the video image;

FIG. 8B shows a display example in the imaging apparatus according to the present embodiment where display content changes depending on how far the main subject moves from the center of the video image, and shows an example where the main subject moves close to the center of the video image;

FIG. 9A shows a display example in the imaging apparatus according to the present embodiment in case where display content changes depending on the location of the main subject in the video image, and shows a display example in case where the main subject is likely to go out of the frame;

FIG. 9B shows a display example in the imaging apparatus according to the present embodiment in case where display content changes depending on the location of the main subject in the video image, and shows a display example in case where the main subject is little likely to go out of the frame;

FIG. 10A illustrates a summary of a method of implementing screen display shown in FIG. 8, and shows the motion of the main subject of FIG. 8A;

FIG. 10B illustrates a summary of a method of implementing screen display shown in FIG. 8, and shows the motion of the main subject of FIG. 8B;

FIG. 11 illustrates a summary of another method of implementing screen display shown in FIG. 8;

FIG. 12A shows a display example in the imaging apparatus according to the present embodiment applying the motion of the main subject to a display for warning for frame-out prevention, and shows an example in case where the main subject is likely to go out of the frame in the direction toward the left side of the display screen;

FIG. 12B shows a display example in the imaging apparatus according to the present embodiment applying movement of the main subject to a display for warning for frame-out prevention, and shows an example in case where the main subject is likely to go out of the frame in the direction toward the lower left side of the display screen; and

FIG. 13 shows a display example in the imaging apparatus according to the present embodiment showing a trajectory of movement of the main subject.

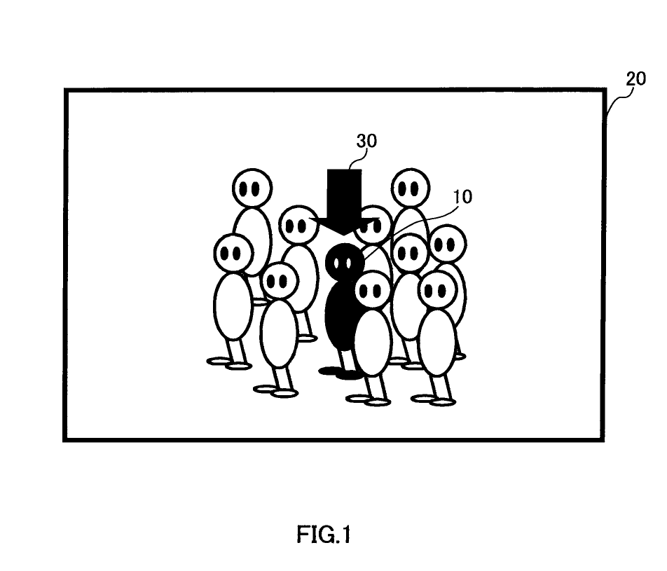

### DETAILED DESCRIPTION OF THE PREFERRED EMBODIMENT

Hereinafter, an embodiment of the present invention will be explained in detail with reference to the accompanying drawings.

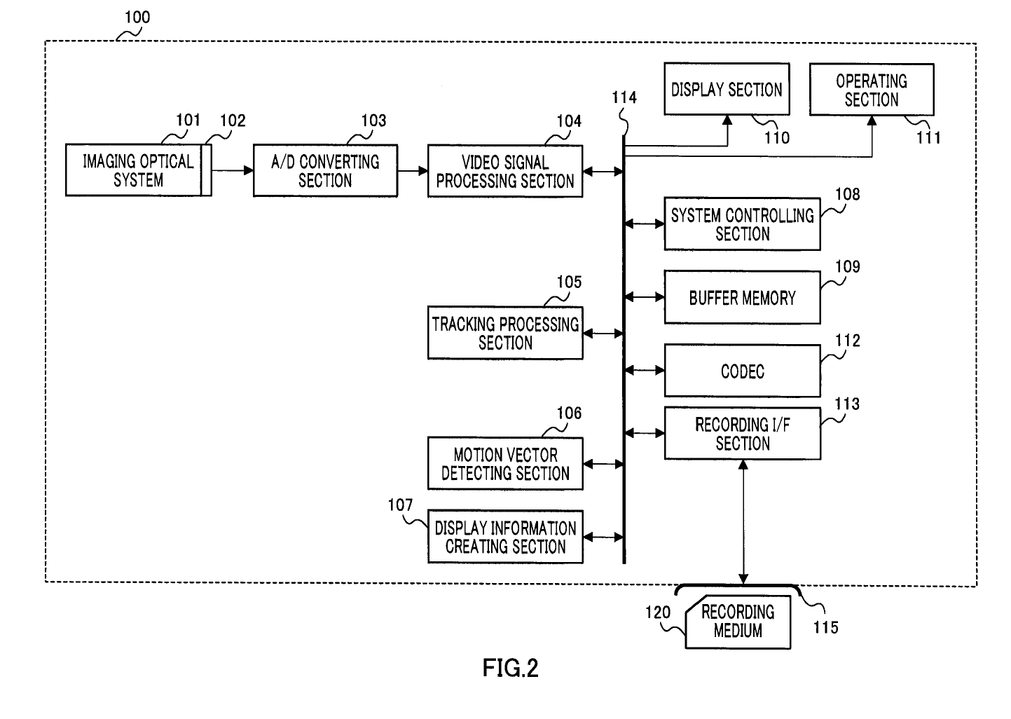

FIG. 2 is a block diagram showing a configuration of an imaging apparatus according to an embodiment of the present invention. The present embodiment is an example where the present invention is applied to a home video camera or camcorder with a tracking function for tracking the main subject.

In FIG. 2, video camera 100 has: imaging optical system 101; solid-state image sensor 102; A/D (analog-to-digital) converting section 103; video signal processing section 104; tracking processing section 105; motion vector detecting section 106; display information creating section 107; system controlling section 108; buffer memory 109; display section 110; operating section 111; CODEC (coder-decoder) 112; recording interface (I/F) section 113; system bus 114 connecting these components reciprocally; and socket 115. Recording medium 120 is attachable to socket 115.

Imaging optical system 101 is formed with a plurality of lenses including a focus lens which moves along an optical axis for adjusting the focus adjustment state and a zoom lens which moves along the optical axis for varying the magnification of an optical image of the subject, and forms an image of the subject on solid-state image sensor 102.

Solid-state image sensor 102 converts the subject image formed by imaging optical system 101 into an electrical signal (video signal). Solid-state image sensor 102 may be, for example, a CCD (charge coupled device) or CMOS (complementary metal oxide semiconductor).

A/D converting section 103 converts an analog video signal outputted from solid-state image sensor 102 into a digital video signal.

Video signal processing section 104 carries out common video signal processing such as gain adjustment, noise cancellation, gamma correction, aperture processing and knee processing for the digital video signal outputted from A/D converting section 103, and converts the digital signal into an RGB format video signal. Further, video signal processing section 104 converts the generated RGB format video signal into a Y/C format video signal.

Tracking processing section 105 tracks a subject which is designated at random, based on the generated image data. Tracking processing section 105 holds data of features of the main subject of the tracking target, carries out processings such as downsizing or color conversion of image data appropriately based on the video signal (image data) sequentially received from video signal processing section 104 and specifies an area that is highly correlated with the data of features of the main subject using a known tracking processing technique. The methods of image processing for implementing such tracking processing includes template matching and particle filtering. Although various formats such as image data itself, brightness information, color histogram or shape may be possible as data of features of the main subject, the data of features is determined depending on the content of image processing for implementing tracking processing. Further, tracking processing may be implemented by carrying out face detection successively with respect to each image data. In this case, the data of features means information about the shapes of the parts of the face or the ratio of the distances between the parts of the face. Tracking processing result information acquired in tracking processing section 105 is sent to system controlling section 108 through system bus 114.

Although not shown, motion vector detecting section 106 has: various filters that carry out band limitation required to apply a representative point matching method to digital video data acquired from buffer memory 109; a memory that stores representative point information which is stored in the previous field or earlier field and which is the reference point for detecting a motion; and a representative point matching arithmetic operation section that extracts detection points for detecting motion vectors from motion vector detection image data acquired through these filters and that carries out representative point matching based on representative point information stored in the memory. Motion vector detecting section 106 detects a motion vector of a video image based on the representative point matching method.

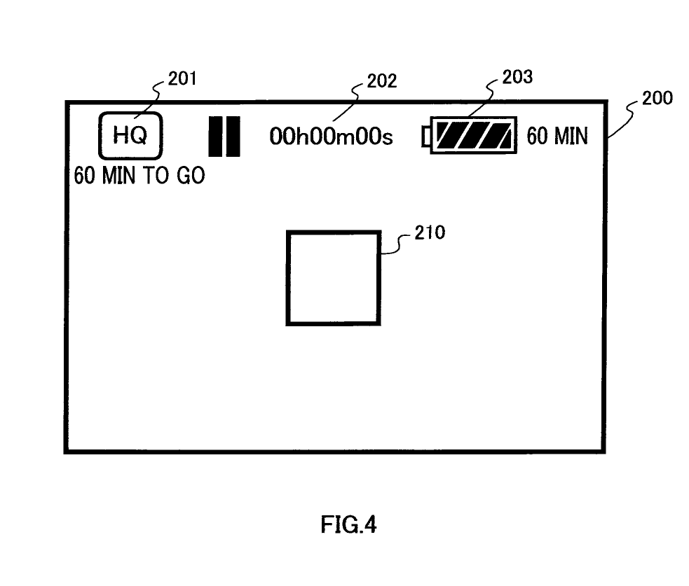

Display information creating section 107 creates display information showing the state of the main subject that is being tracked, based on the motion of the main subject that is being tracked (i.e. on tracking) in the display screen in display section 110 and/or the location of the main subject that is being tracked in the display screen. Display information creating section 107 creates display information for calling for user's attention to prevent the user from losing the sight of the main subject that is being tracked or the main subject that is being tracked from going out of the frame in display screen 200 (explained below using FIG. 4 and the same applies below). To be more specific, display information that is created includes (1) location change information which shows changes in the location of the main subject that is being tracked, (2) a display of the motion vector of the main subject that is being tracked, (3) a display of the direction toward which the main subject that is being tracked is likely to go out of the frame on display screen 200, (4) its highlight (i.e. a display for emphasizing the direction), (5) a display of how far the center of display screen 200 is from the location of the main subject that is being tracked, (6) a display of the distances between four of the upper, lower, left and right sides of display screen 200 and the location of the main subject that is being tracked, (7) a display of a trajectory of a tracking result history in tracking processing section 105 and (8) a warning message.

System controlling section 108 is formed with a CPU, a ROM that records the control program and a RAM for executing the program, and controls the operation of each section of video camera 100 connected with system bus 114. Further, system controlling section 108 includes a FIFO (first-in first-out) memory (not shown) and accumulates tracking processing result history.

System controlling section 108 integrally controls: processing of user operation information acquired in operating section 111; accumulation and processing of tracking result information acquired in tracking processing section 105; operation control in video signal processing section 104, tracking processing section 105, motion vector detecting section 106 and display information creating section 107; generation of display data displayed in display section 110; execution and termination control of compression processing of digital video data in CODEC 112; and data transfer control between buffer memory 109 and recording I/F section 113.

System controlling section 108 downsizes digital video data on buffer memory 109 to an appropriate data size to display in display section 110. As OSD (on screen display) displays, system controlling section 108 generates items of information such as the remaining recording time, which is calculated based on the remaining capacity of recording medium 120 and the degree of compression in the compression processing of digital video data carried out in CODEC 112, the battery level and an icon representing recording stand-by mode. Then, system controlling section 108 superimposes the generated OSD displays upon digital video data that is downsized and displays the result in display section 110.

Further, system controlling section 108 is configured to include a GUI (graphical user interface) displaying OSD function for generating GUI's for related information. System controlling section 108 displays output video data acquired by superimposing OSD displays such as various operation icons and character sequence data upon digital video data. A video image apparatus such as a video camera generally displays information such as various operation icons and character sequence data on a screen. OSD data is not held in images. Instead, OSD data is held in the format referred to as “bitmap.” This OSD data is converted from this bit map to a YUV format pixel value represented by Y, Cb and Cr. This converted pixel value is superimposed upon an original image such as an input image.

Particularly, system controlling section 108 superimposes display information created in display information creating section 107 upon the main subject that is being tracked, and controls display section 110 to display the result. Further, system controlling section 108 superimposes display information created in display information creating section 107 upon image data created in video signal processing section 104 using the OSD function, and controls display section 110 to display the result.

Buffer memory 109 accumulates the digital video signal outputted from video signal processing section 104 through system bus 114 as digital video data.

Display section 110 is a monitor and includes a D/A (digital-to-analog) converting section (not shown) and a small liquid crystal panel. Display section 110 inputs digital video data accumulated in buffer memory 109 in the liquid crystal panel through the D/A converting section according to a command from system controlling section 108 and displays digital video data as a visible image.

Operating section 111 includes various buttons and levers for operating video camera 100. For example, operating section 111 includes various buttons and levers such as a mode switching button, zoom lever, power supply button, shooting button, menu button, direction button and enter button (all not shown). The mode switching button refers to a button for switching between a plurality of operation modes of video camera 100. These operation modes include normal shooting mode for normal shooting, tracking shooting mode for shooting images while tracking the main subject and playback mode for playing back video data that is shot. The zoom lever refers to a lever for zooming images. The power supply button refers to a button for turning on and off the main power supply of video camera 100. The shooting button refers to a button for starting and stopping shooting images. The menu button refers to a button for displaying various menu items related to the setting of video camera 100. The direction button can be pressed up, down, left, right and in, and refers to a button for switching the position to zoom and menu items. The enter button refers to a button for carrying out various enter operations.

CODEC 112 is formed with, for example, a DSP (digital signal processor) and carries out invertible compression processing of digital video data accumulated in buffer memory 109. CODEC 112 converts the digital video data accumulated in buffer memory 109 into compressed video data of a predetermined format such as MPEG-2 (Moving Picture Experts Group phase 2) or H.264/MPEG-4 AVC (Moving Picture Experts Group phase 4 Part 10 Advanced Video Coding).

Recording I/F section 113 is electrically connected with recording medium 120 through socket 115.

Socket 115 is a slot for attaching recording medium 120 which is installed in the video camera 100 body. By attaching recording medium 120 to this socket 115, compressed video data that is compressed and generated in CODEC 112 is recorded in recording medium 120.

Recording medium 120 is a removable memory such as a memory card that is detachable from socket 115 and preferably has a general configuration such that recording medium 120 can be used in general hardware devices. Recording medium 120 is a memory card such as an SD memory card. Further, recording medium 120 may be Compact Flash (registered utility model) (CF), Smart Media (registered utility model) and Memory Stick (registered utility model) formed with an SRAM (Static RAM) card which holds information written by power supply backup and a flash memory which does not require power supply back up. Further, recording medium 120 may be a hard disc drive (HDD) or an optical disc.

The operation of video camera 100 with the subject recognition function and the tracking function configured as explained above will be explained below.

First, the tracking processing operation in tracking processing section 105 will be explained.

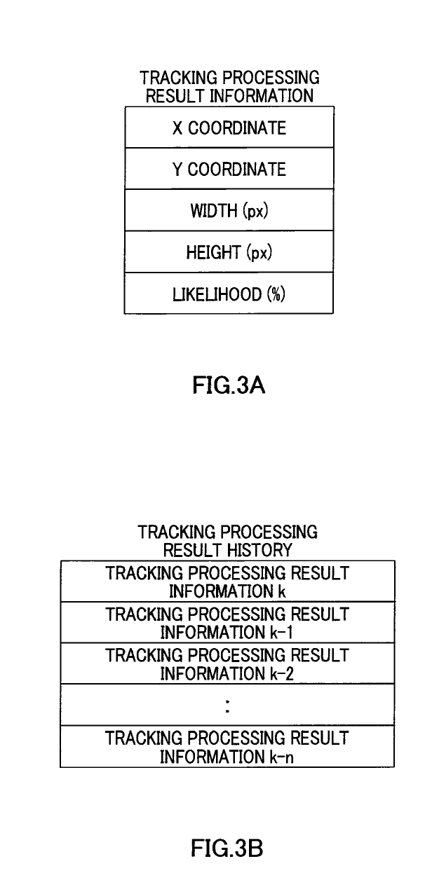

FIG. 3 shows content of tracking processing result information and tracking processing result history acquired in tracking processing section 105. Particularly, FIG. 3A shows content of tracking processing result information acquired in tracking processing section 105 and FIG. 3B shows content of tracking processing result history accumulated in a FIFO (First-In First-Out) memory (not shown) in system controlling section 108.

As shown in FIG. 3A, tracking processing result information acquired in tracking processing section 105 is configured with the location of the area that is determined (X coordinate and Y coordinate in an upper left area), the size of the area (width and height of the area) and information of reliability (likelihood) indicating that the determined area is the main subject. The likelihood refers to the similarity of the data of features and is determined depending on the tracking processing carried out in tracking processing section 105. For example, when color histogram is used as data of features of the main subject, the likelihood refers to the similarity of the color histogram and the similarity can be calculated using the histogram intersection method. Further, when face detection is carried out in tracking processing section 105 as tracking processing, the likelihood refers to the similarity of the characteristics of the face. In addition, when edge shape information of main subject 300 is used as data of features, the similarity of the edge shape is used, and, when the distribution of brightness is used as data of features, the similarity of brightness is used.

This tracking processing result information is transmitted from tracking processing section 105 to system controlling section 108 and, as shown in FIG. 3B, a predetermined number of items of tracking processing result information are accumulated in the FIFO memory in system controlling section 108. The tracking processing result history shown in FIG. 3B is stored in the FIFO memory. The tracking processing result history that is stored earliest is extracted from the FIFO memory first. When new tracking processing result information is added, the earliest tracking processing result information is discarded.

Next, the details of processing in case where an image is shot while tracking the main subject will be explained.

First, when normal shooting mode or tracking shooting mode for recording an image is selected by the mode switching button provided in operating section 111, video camera 100 enters recording stand-by mode of continuously displaying images of the subject acquired from imaging optical system 101 in display section 110. To be more specific, the subject image is formed in solid-state image sensor 102 through imaging optical system 101 and is photoelectrically converted to generate a video signal. The generated video signal is subjected to A/D conversion processing by A/D converting section 103 and common video signal processing by video signal processing section 104 and then is accumulated as digital video data in buffer memory 109 through system bus 114. System controlling section 108 downsizes digital video data on buffer memory 109 to an appropriate data size to display in display section 110. Then, as OSD displays, system controlling section 108 generates various items of information such as the remaining recording time, which is calculated based on the remaining capacity of recording medium 120 and the degree of compression in the compression processing of digital video data carried out in CODEC 112, the battery level, and an icon showing recording stand-by mode. Then, system controlling section 108 superimposes the generated OSD displays upon digital video data that is downsized and displays digital video data in display section 110.

Next, a display operation when tracking shooting mode is selected will be explained.

FIG. 4 shows a display example in display section 110 in recording stand-by mode upon tracking shooting mode.

As shown in FIG. 4, frame 210 is displayed in the center of display screen 200 of display section 110. This is a frame for designating the main subject as the tracking target. Further, in the upper part of display screen 200, remaining recording time icon 201, record/stop and recording time icon 202 and battery remaining time icon 203 are displayed.

In this state, when the shooting button provided in operating section 111 is pressed, recording processing followed by the following tracking processing starts.

When recording starts, system controlling section 108 commands tracking processing section 105 to start tracking processing. When receiving a command to start tracking processing, tracking processing section 105 accesses buffer memory 109, generates data of features of the main subject from the digital video data corresponding to the area in frame 210 and holds the data of features in the memory in tracking processing section 105. Further, system controlling section 108 commands CODEC 112 to start compression processing of digital video data. When receiving the command to start compression processing of digital video data, system controlling section 108 starts compressing digital video data on buffer memory 109. The compressed digital video data is placed on buffer memory 109 in the same manner before compression. System controlling section 108 transfers the compressed digital video data to recording I/F section 113. Recording I/F section 113 writes the compressed digital video data into recording medium 120 through socket 115.

As in recording stand-by mode, video signal processing section 104 sequentially outputs digital video data to buffer memory 109. During recording, every time digital video data is updated, compression processing in CODEC 112 and writing of compressed digital video data into recording medium 120 are carried out successively. Further, during recording, system controlling section 108 carries out generation and updating processings of OSD displays, by, for example, displaying a recording time counter and updating the battery level.

In parallel with the above recording processing, tracking processing section 105 carries out tracking processing of digital video data on buffer memory 109, based on the data of features generated and held when recording starts. Tracking processing result information resulting from tracking processing is accumulated in the memory in system controlling section 108. System controlling section 108 generates a display showing the state of tracking processing (explained later) as part of the OSD displays based on tracking processing result information and the like. As in recording stand-by mode, the OSD displays generated by system controlling section 108 are superimposed upon the digital video data that is downsized and then displayed on display screen 200.

The details of processing in video camera 100 in case where the shooting is performed while the main subject is tracked have been explained. Display content showing the state of tracking processing will be explained below.

FIG. 5 is a flowchart showing steps of display information creation processing in display information creating section 107. In FIG. 5, “S” refers to each step in the flowchart.

First, in step S11, system controlling section 108 decides whether or not operation mode is tracking shooting mode. Mode is selected by the mode switching button provided in operating section 111. When video camera 100 transitions to tracking shooting mode by the mode switching button, the flow proceeds to step S12 and tracking shooting mode starts. Further, if operation mode is not tracking shooting mode, the display information creation processing is finished immediately.

Then, in step S12, video signal processing section 104 carries out video signal processing of the digital video signal outputted from A/D converting section 103 and outputs one frame of an RGB format video signal.

Then, in step S13, tracking processing section 105 carries out tracking processing. With the present embodiment, this tracking processing includes storing the features of the main subject when tracking starts and searching from an input image for an area highly correlated with the stored features during tracking processing.

Then, in step S14, tracking processing section 105 decides whether or not the main subject is successfully detected as a result of tracking processing in step S13. If the main subject is not successfully detected as a result of tracking processing, the display information creation processing is finished immediately. Further, if the main subject is successfully detected as a result of tracking processing, the flow proceeds to step S15.

In step S15, motion vector detecting section 106 detects a motion vector of the main subject. In processing of detecting the motion vector of the main subject, motion vector detecting section 106 detects a motion of the subject that is the shooting target by tracking representative points of the shot images and outputs the motion vector.

Then, in step S16, system controlling section 108 detects the image location of the main subject. A specific example of a method of detecting the image location of the main subject will be explained below.

Then, in step S17, system controlling section 108 receives a report signal showing that the main subject is being tracked (i.e. on tracking), from tracking processing section 105, and decides whether or not the main subject is being tracked. When the main subject is not being tracked, the flow returns to step S13 and continues tracking processing. Further, when the main subject is being tracked, the flow proceeds to step S18.

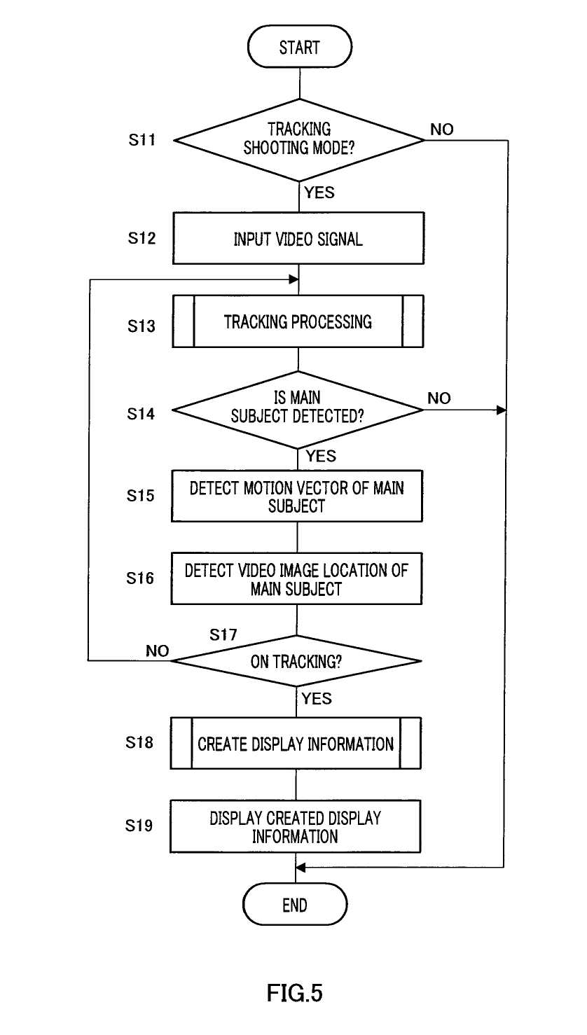

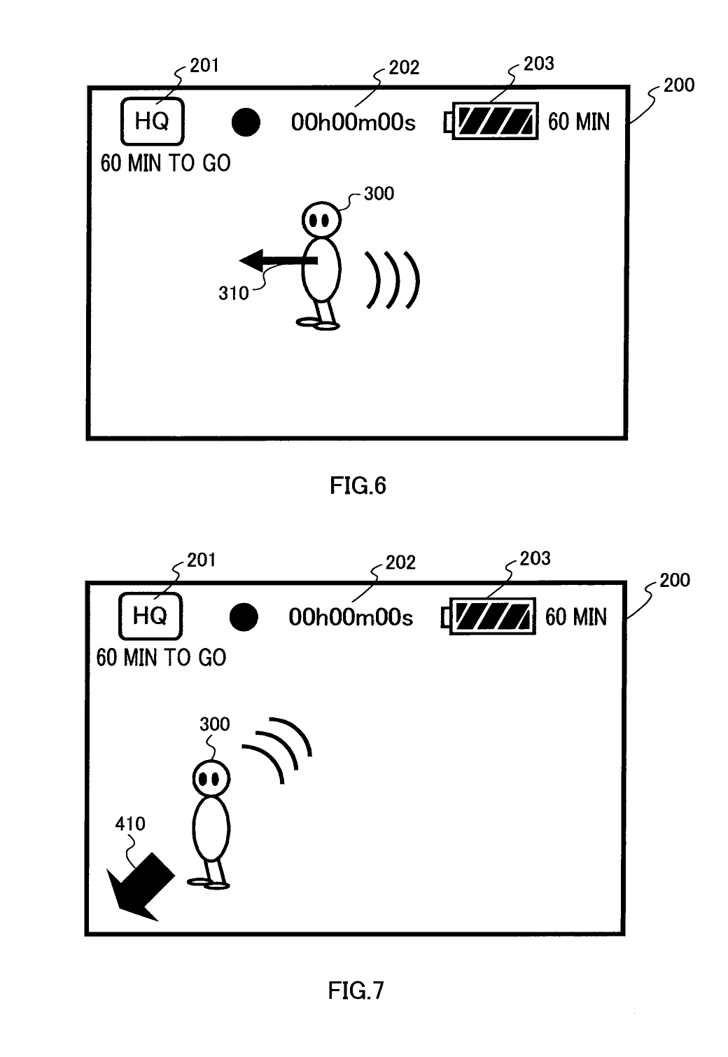

In step S18, display information creating section 107 creates information (display information) that is beneficial when an image is shot to prevent the main subject from going out of the frame, based on resources accumulated in system controlling section 108 (for example, tracking processing result history, the motion vector and location information of the main subject, and the distance between the main subject and the center of the screen). The specific creating method will be explained in more detail using FIG. 6 to FIG. 13.

Then, in step S19, system controlling section 108 superimposes the display information created in display information creating section 107 upon digital video data using the OSD function, displays the digital video data in display section 110 and then finishes the display information creation processing.

In this way, with the present embodiment, display information creating section 107 creates information (display information), such as the motion vector of the subject or the distance between the main subject and the center of the screen, that is beneficial when an image is shot to prevent the subject from going out of the frame. Then, system controlling section 108 displays the created information on display screen 200 of display section 110 such that the user can know the created information.

Display information creating section 107 creates display information which is necessary for the user not to lose the sight of the subject that is being tracked by the tracking processing operation in tracking processing section 105. Hereinafter, specific display examples of the state of tracking processing created in display information creating section 107 will be explained.

[Motion Vector Display 1]

FIG. 6 shows a display example of the motion vector of the main subject of the tracking target. The same part as in the display example of FIG. 4 will be assigned the same reference numerals in the following figures.

In FIG. 6, main subject 300 is displayed in virtually the center of display screen 200 of display section 110. Arrow 310 is a motion vector representing the moving direction and moving speed of main subject 300 and is displayed on display screen 200 by superimposing arrow 310 upon main subject 300. Arrow 310 showing this motion vector is displayed by the OSD function of display section 110. That is, display information creating section 107 creates information (here, arrow 310) that is beneficial when an image is shot to prevent the subject from going out of the frame, and this display information is displayed by the OSD function on display screen 200. Further, display information in FIG. 7 to FIG. 13 (explained later) will be displayed by the OSD function.

Display information creating section 107 calculates the motion vector of main subject 300 using the tracking processing result history accumulated in system controlling section 108. In FIG. 6, arrow 310 displays the motion of main subject 300 moving to the left side on display screen 200 as the motion vector of main subject 300.

Various motion vector calculating methods are possible. For example, the motion vector may be determined by acquiring the differences between location information of preceding fields and subsequent fields by going back over a predetermined number of fields and finding the average of these differences. Further, the motion vector may be calculated by multiplying the difference in each location information with a predetermined weight and finding the average between the weighted differences.

Further, the center of main subject 300, which is the start point of arrow 310, may be calculated using the location (X coordinate and Y coordinate) and the size (width and height) of main subject 300, which are tracking processing result information. The value adding half of the width of main subject 300 to the X coordinate of main subject 300 is the X coordinate of the center of main subject 300. Further, the value adding half of the height of main subject 300 to the Y coordinate of main subject 300 is the Y coordinate of main subject 300.

By displaying the motion vector of main subject 300, the user is able to readily know the moving direction and moving speed of the tracking target. Consequently, the user is able to adjust the shooting range to prevent main subject 300 from going out of the frame and stop recording before continuing tracking processing becomes impossible due to the occurrence of occlusion where main subject 300 hides behind other objects.

[Motion Vector Display 2]

Next, a modified example of the above motion vector display will be explained.

With the motion vector display according to this modified example, when the motion vector of main subject 300 is calculated, the motion vector involving the panning and tilting operations of video camera 100 will be taken into account.

Display information creating section 107 calculates the motion vector of main subject 300 as in the above method. This calculated motion vector will be referred to as “apparent motion vector.” This is because the calculated motion vector is a relative motion vector subtracting the motion vector of video camera 100 from the original motion vector of main subject 300.

Motion vector detecting section 106 detects the motion vector of video camera 100 itself. Then, motion vector detecting section 106 acquires the original motion vector of main subject 300 by adding the motion vector of video camera 100 itself to the apparent motion vector.

By displaying the original motion vector acquired in this way on display screen 200 as in FIG. 6, it is possible to present the original motion of main subject 300 that does not depend on the motion of video camera 100. With the example of FIG. 6, when main subject 300 and video camera 100 move in parallel at the same speed, the magnitude of the motion vector of main subject 300 is decided to be practically zero. By contrast with this, with the present modified example, the original motion vector of main subject 300 is displayed on display screen 200 irrespective of the notion of video camera 100.

Although not shown, there are cases where various sensors including a gyro sensor for finding the motion of the video camera are mounted in a video camera with a function of preventing the shake of the hand. In such cases, the motion vector of the video camera itself is detected based on information about various sensors in the video camera without using image processing of the representative point matching method.

[Display for Frame-Out Prevention]

FIG. 7 shows a display example applying the motion vector of main subject 300 to a display for frame-out prevention.

If the motion vector of main subject 300 is constant, it is possible to predict the time left until frame-out occurs, that is, predict after how many fields main subject 300 goes out of the frame, from the location of main subject 300 and the motion vector of main subject 300.

When the predicted remaining time left until frame-out occurs goes below a predetermined threshold, display information creating section 107 creates warning display 410 for displaying the frame-out prediction location of main subject 300. Then, system controlling section 108 displays created warning display 410 on display screen 200 of display section 110.

Here, display section 110 displays warning display 410 by a flash. System controlling section 108 displays warning display 410 on display screen 200 by changing the flashing interval depending on the predicted remaining time left until frame-out occurs. This flashing interval is shortened as the predicted remaining time left until frame-out occurs decreases, to report the high degree of urgency to the user.

Thanks to this display, the user is able to learn in advance the direction and timing main subject 300 goes out of the frame, change the shooting range of video camera 100 to prevent frame-out and stop shooting images.

[Display of the Distance from the Center of the Screen]

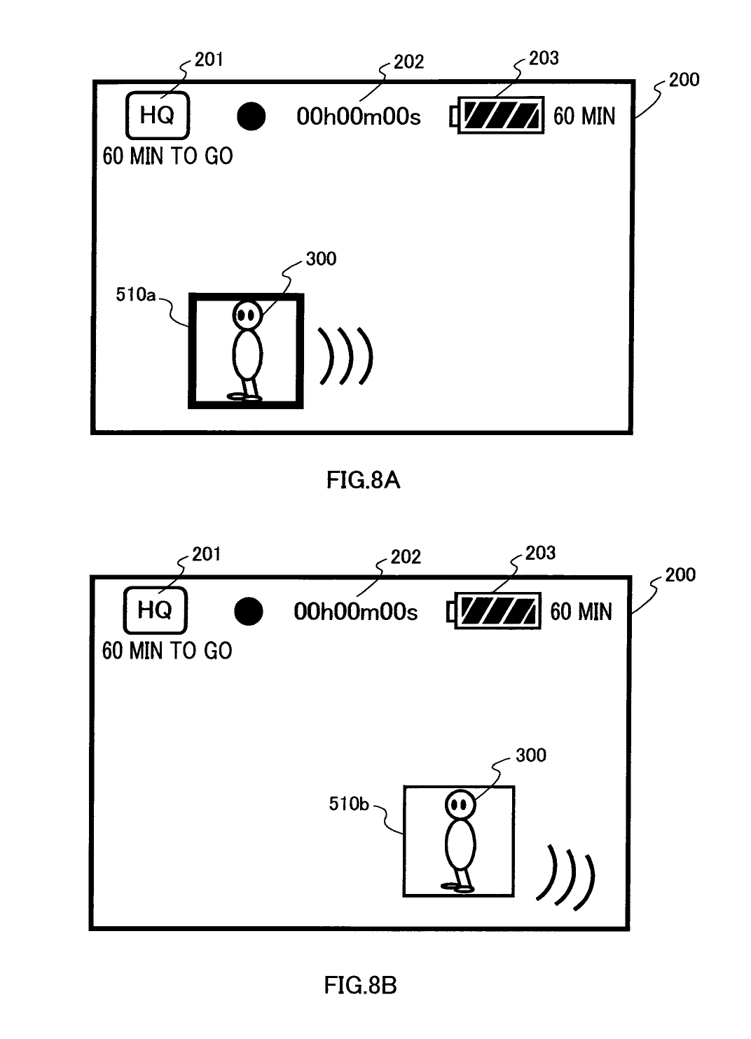

FIG. 8 shows a display example where display content is changed depending on how far main subject 300 moves from the center of the video image (that is, the screen). Particularly, FIG. 8A shows an example where main subject 300 moves far from the center of the video image and FIG. 8B shows an example where main subject 300 comes close to the center of the video image.

With the present example of displaying the state of tracking processing in video camera 100, display content is changed depending on how far main subject 300 moves from the center of the video image.

In FIG. 8A, main subject 300 moves far from the center of the video image, and, in FIG. 8B, main subject 300 comes close to the center of the video image. Consequently, main subject 300 of FIG. 8A is likely to go out of the frame compared to main subject 300 of FIG. 8B, so that the line of frame 510a showing the location of main subject 300 is drawn bold and displayed to be more distinct than in FIG. 8B. To be more specific, motion vector detecting section 106 detects the motion vector of main subject 300 moving close to or far from the center of display screen 200. Further, display information creating section 107 creates frames 510a and 510b showing how close main subject 300 comes to the center of display screen 200, based on the motion vector that starts from the center of detected main subject 300. Then, system controlling section 108 makes display section 110 display created frames 510a and 510b on display screen 200.

Various methods of calculating the motion vector of main subject 300 are possible as explained above. For example, the motion vector may be determined by acquiring the differences between location information of preceding fields and subsequent fields by going back over a predetermined number of fields and finding the average of these differences. Further, the motion vector may be calculated by multiplying the difference in each location information with a predetermined weight and finding the average between the weighted differences.

In this way, with this example, display content is changed depending on how close the motion vector, which starts from the center of main subject 300, comes to the center of the video image. As shown in FIG. 8A, main subject 300 that is likely to go out of the frame, is displayed by bold frame 510a. Further, as shown in FIG. 8B, main subject 300 that is little likely to go out of the frame, is displayed by thin frame 510b.

Here, for main subject 300 that is likely to go out of the frame, bold frame 510a may be displayed with an emphasis depending on the possibility of frame-out. For example, bold frame 510a may be made bolder as main subject 300 moves far from the center of the video image. Further, bold frame 510a may be flashed by combining the above method of flashing warning display 410 or the color of bold frame 510a may be changed to a more distinct color

[Display According to the Location in the Screen]

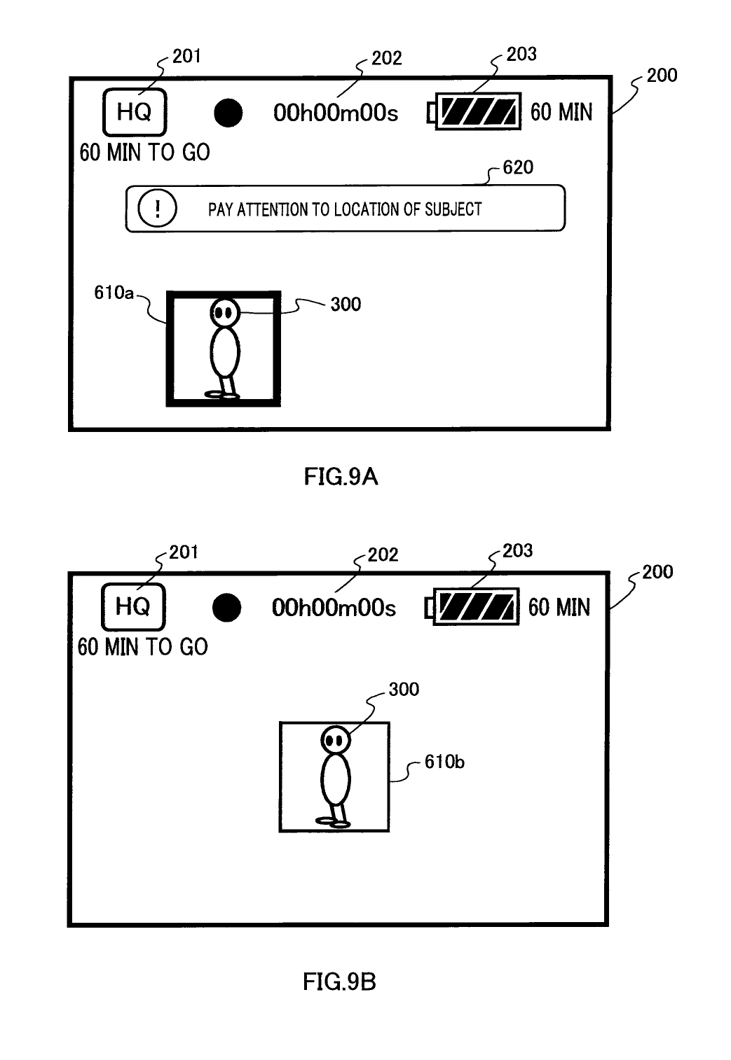

FIG. 9 shows a display example where display content is changed according to the location of main subject 300 in the image (that is, on the screen). That is, FIG. 9 shows a display example where display content is changed according to the location of main subject 300 in the video image as another example of display of the state of tracking processing in video camera 100. Particularly, FIG. 9A shows a display example where the main subject is likely to go out of the frame and FIG. 9B shows a display example where the main subject is little likely to go out of the frame.

In FIG. 9A and FIG. 9B, frame 610a and frame 610b are displayed based on the location and size of main subject 300, which are tracking processing result information. Upon comparison between the location of main subject 300 in FIG. 9A and the location of main subject 300 in FIG. 9B, main subject 300 in FIG. 9A is located closer to the rim of the video image. Naturally, main subject 300 in FIG. 9A is more likely to go out of the frame than main subject 300 in FIG. 9B. Then, frame 610a in FIG. 9A is displayed on display screen 200 to be more distinct than frame 610b in FIG. 9B.

With this example, to implement the display shown in FIG. 9, how far the center of main subject 300 is from the center of the video image is determined from tracking processing result information and display content is changed according to the determined distance. An example of the calculation method of determining how far the center of main subject 300 is from the center of the video image will be explained below.

First, the distances between the center of main subject 300 (Mx, My) and the center location of the video image (Cx, Cy) are determined in the X direction and the Y direction.

When the distance in the X direction is Dx and the distance in the Y direction is Dy, Dx and Dy can be determined from |Cx−Mx| and |Cy−My|, respectively.

The maximum value of Dx is Cx and the maximum value of Dy is Cy, so that Dx′ and Dy′ adopt values from 0 to 1 by dividing Dx by Cx to obtain Dx′ and dividing Dy by Cy to obtain Dy′. The values of Dx′ and Dy′ show that, as the values of Dx′ and Dy′ come closer to 1, main subject 300 is coming closer to the end of the video image.

The display on display screen 200 shown in FIG. 9 is implemented by changing display content in proportion to the minimum values of Dx′ and Dy′, that is, Min (Dx′, Dy′), acquired in this way.

Further, when Min (Dx′, Dy′) goes beyond a predetermined threshold, warning display 620 may be displayed on display screen 200 to call for user's attention more.

[The Implementing Method 1 of a Screen Display of FIG. 8]

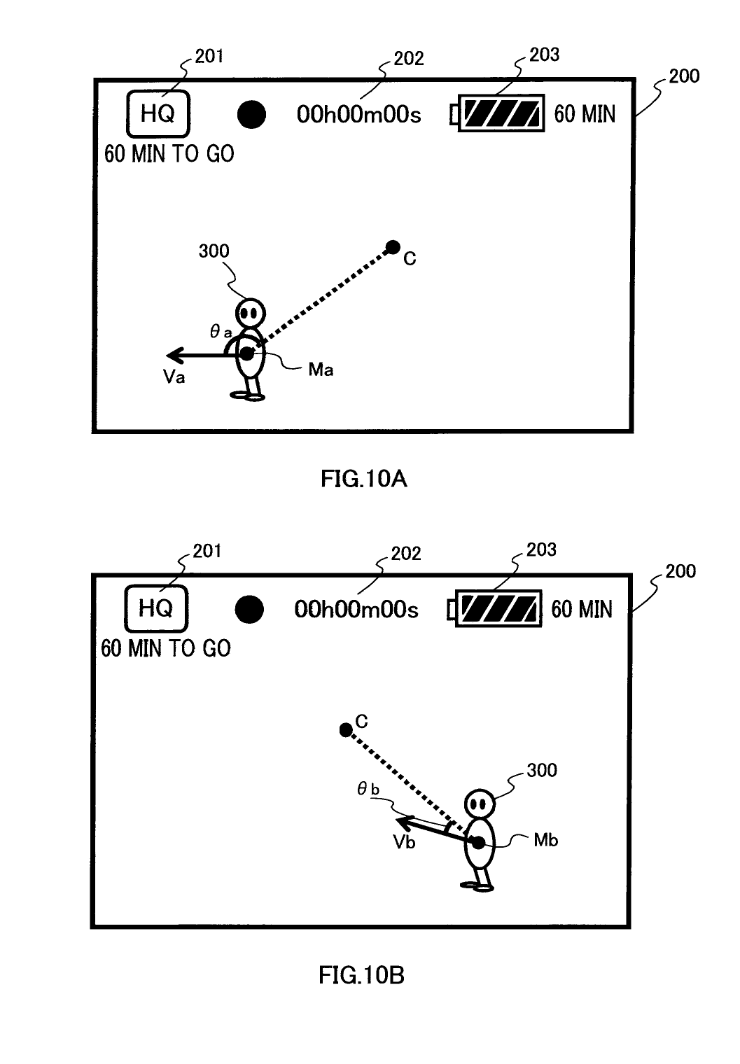

FIG. 10 illustrates a summary of the method of implementing the screen display shown in FIG. 8. Particularly, FIG. 10A shows the motion of the main subject of FIG. 8A and FIG. 10B shows the motion of the main subject of FIG. 8B.

In FIG. 10A, the angle θa formed between the line connecting the center Ma of main subject 300 and the center C of the video image and the motion vector Va of main subject 300 starting from Ma is determined. The unit of θa is radian, and θa adopts values between −π and π. It can be decided that main subject 300 is moving toward the center C of the video image if the absolute value |θa| of θa is in the range between 0 and ½π, and that main subject 300 is moving farther from the center C of the video image if |θa| is in the range between ½π and π. Further, it can be decided that main subject 300 is moving toward the center C of the video image if |θa| is closer to 0, and that main subject 300 is moving farther from the center C of the video image if |θa| is closer to π. In FIG. 10A showing the motion of main subject 300 of FIG. 8A, |θa| exceeds ½π, which means that main subject 300 is moving farther from the center C of the video image. By contrast with this, in FIG. 10B showing the motion of main subject 300 of FIG. 8B, the absolute value |θb| of the angle θb formed between the line connecting the center Mb of main subject 300 and the center C of the video image and the motion vector Vb of main subject 300 starting from Mb, is in the range between 0 and ½π, which means that main subject 300 is coming closer to the center C of the video image.

As the absolute value |θ| of the angle θ formed between the line connecting the center of main subject 300 and the center C of the video image and the motion vector of main subject 300 starting from the center of main subject 300 increases, the width of the frame encompassing main subject 300 is made bolder, so that the screen display shown in FIG. 8 is implemented.

[The Implementing Method 2 of the Screen Display of FIG. 8]

With above implementing method 1, how far main subject 300 is from the center of the video image is determined based on the distance between main subject 300 and the center of the video image and the vector of main subject 300. With implementing method 2, how far main subject 300 is from the center of the video image is determined utilizing the distances from the upper, lower, left and right sides of the video image to main subject 300.

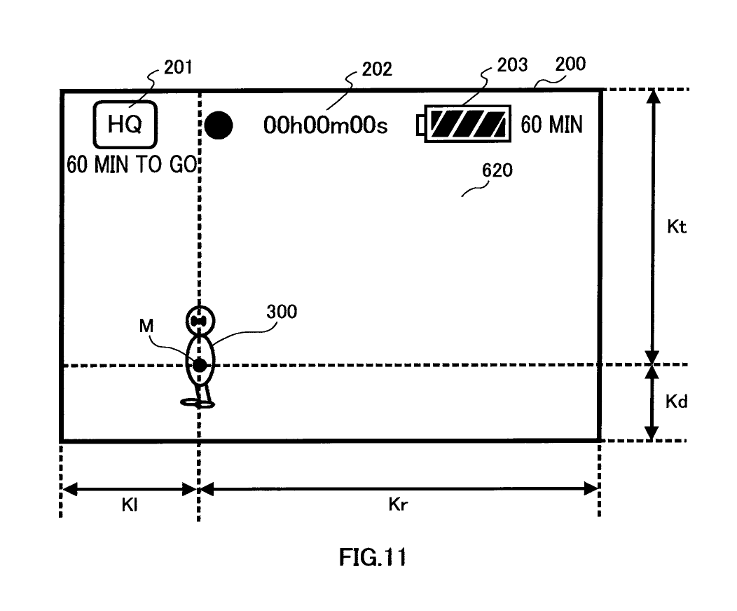

FIG. 11 illustrates a summary of another implementing method of the screen display shown in FIG. 8 and shows the distances from the upper, lower, left and right sides of the video image to main subject 300. As shown in FIG. 11, the distances from the center M of main subject 300 to the upper, lower, left and right sides of the video image are Kt, Kd, Kl and Kr, respectively. In FIG. 11, the minimum value Min (Kt, Kd, Kl and Kr) among Kt, Kd, Kl and Kr is Kd, and, therefore, the width of frame 610 in FIG. 9 is determined based on the value of Kd.

Further, the size of the video image in the vertical direction is shorter than in the horizontal direction, and, if Min (Kt, Kd, Kl and Kr) is divided by Cy, which is the half of the length of the video image in the vertical direction, the range of the value adopted by the divided Min is between 0 and 1. Assuming that this value is Min′, when main subject 300 is coming closer to the end of the video image, the value of Min′ comes close to 0. Consequently, with the present method, the width of frame 610 in FIG. 9 is changed in inverse proportion to Min′

[Display of the Frame-Out Direction]

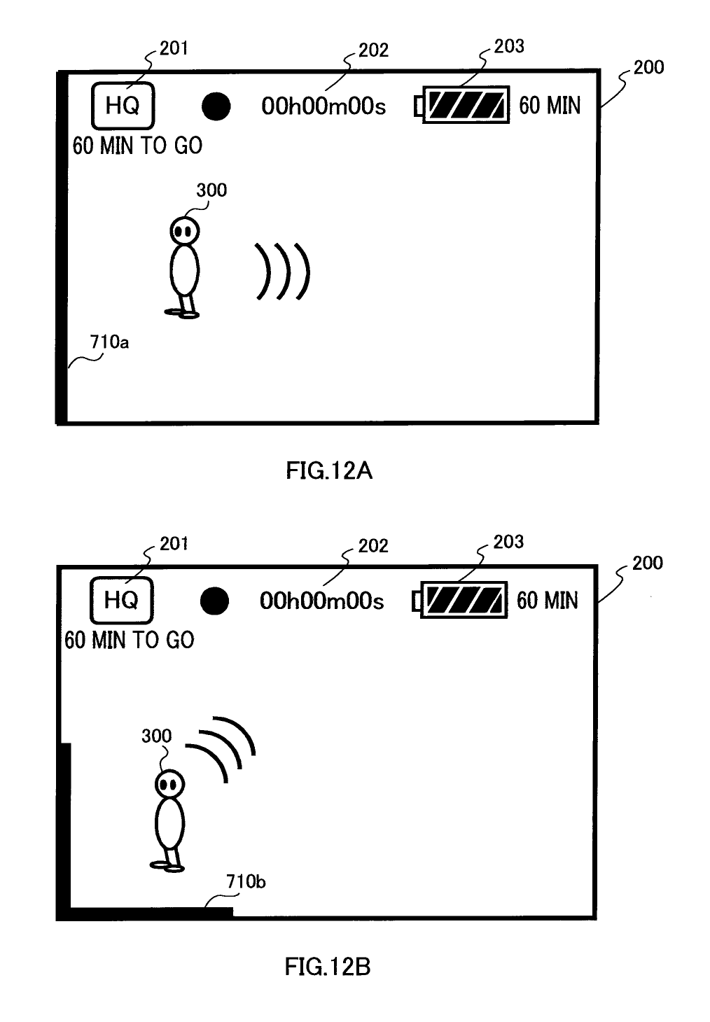

FIG. 12 shows a display example applying movement of main subject 300 to a warning display for frame-out prevention.

With this example, the direction toward which main subject 300 is likely to go out of the frame is displayed on display screen 200. The direction toward which main subject 300 is likely to go out of the frame can be determined based on Dx′ and Dy′ explained in the above implementing method 1 or based on Kt, Kd, Kl and Kr explained in the above implementing method 2. Hereinafter, an example will be explained where a warning display is displayed based on the above implementing method 2, that is, based on the distances from the upper, lower, left and right sides of the video image to the main subject.

In FIG. 12A, main subject 300 is approaching the left side of the video image, and, therefore, main subject 300 is likely to go out of the frame in the left side direction of screen display 200. Then, with the example of FIG. 12A, warning display 710a is displayed in the left side of display screen 200. Further, in FIG. 12B, main subject 300 is approaching the left side and lower side of the video image, and, therefore, main subject 300 is likely to go out of the frame in the lower left direction in screen display 200. Then, with the example of FIG. 12B, warning display 710b is displayed in the lower portion of the left side of display screen 200 and in the left portion of the lower side of display screen 200.

In this way, with this example, according to the values of Kt, Kd, Kl and Kr, which each represent the distance between the center of main subject 300 and each side of display screen 200, warning display 710 is displayed in one of eight of the upper, lower, left, right, upper right, upper left, lower right and lower left directions, to report to the user the direction toward which main subject 300 is likely to go out of the frame. Further, whether or not to display warning display 710 is decided depending on whether or not Kt, Kd, Kl and Kr, which each represent the distance between the center of main subject 300 and each side of display screen 200, go below predetermined thresholds. Further, warning display 710 may be made more distinct as Mm (Kt, Kd, Kl and Kr) become smaller. Further, as explained in FIG. 7, a display may be possible with an arrow.

[Display of a Trajectory of Movement]

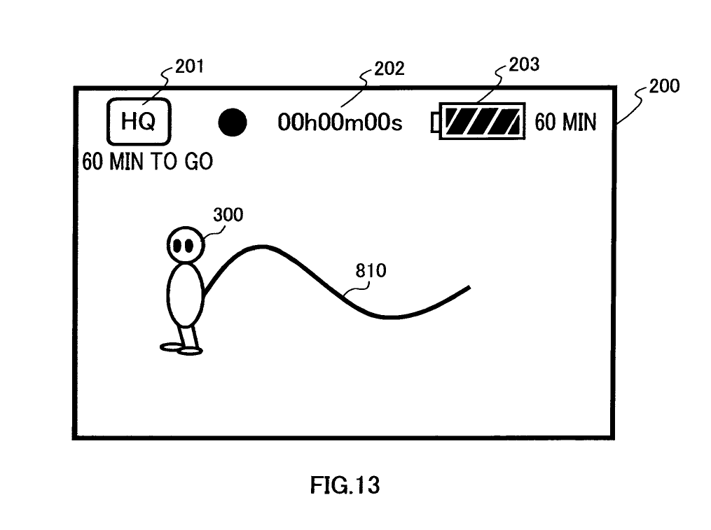

FIG. 13 shows a display example displaying the trajectory of the movement of main subject 300 on the display screen, and shows an example where the trajectory of the movement of main subject 300 is drawn as an example of display of the state of tracking processing in video camera 100.

Display information creating section 107 extracts a predetermined number of items of the latest information from tracking processing result history accumulated in system controlling section 108. Then, display information creating section 107 finds the center position of main subject 300 in each extracted information, and creates display information drawing a curve which smoothly connects a group of resulting center positions.

In FIG. 13, curve 810 shows the trajectory of the movement of main subject 300 in display section 110. Consequently, the user can see the trajectory of past movement of main subject 300, so that it is possible to roughly predict how main subject 300 will move in future and help prevent main subject 300 from going out of the frame. Further, by checking whether or not there is an object in a predicted direction in which the main subject will move, it is possible to roughly know whether or not occlusion will occur.

Further, the width or color of the curve to draw may be changed for improved visibility. For example, color of a curve connecting older information may be drawn lighter or clarity of the curve may be higher.

As explained above, according to the present embodiment, display information creating section 107 creates display information for calling for user's attention not to lose the sight of main subject 300 that is being tracked or not to make main subject 300 go out of the frame, and system controlling section 108 displays on display screen 200 the created display information in association with main subject 300 that is being tracked. Accordingly, apart from a conventional example simply showing an arrow or frame with respect to the subject, it is possible to present to the user information that is beneficial when an image is shot to prevent main subject 300 from going out of the frame. For example, according to the motion of main subject 300, it is possible to change a display by changing the color of a symbol pointing at main subject 300 or by displaying an arrow and changing the direction and size of the arrow. Further, a display symbol may be changed according to the distance from the center of display screen 200. Further, when main subject 300 is close to the end of the display screen, it is possible to display a warning in the direction toward which main subject 300 is likely to go out of the frame. In this way, information showing the state of tracking processing is presented to the user, so that the user can intuitively know that the possibility of frame-out is high or low. Then, the user can readily prevent frame-out of the main subject or occurrence of occlusion. As a result, it is possible to reduce the possibility that shooting images fails and improve the usability of the tracking function.

Further, in mode of display in the above explanation, display information for calling for user's attention is created based on the location of the main subject on display screen 200. Accordingly, even if there is an object similar to the main subject in display screen 200, the user can readily distinguish between the object and the main subject, so that it is possible to provide an advantage of readily preventing failure of shooting images.

The above explanation is the illustration of a preferable embodiment of the present invention and the present invention is not limited to this. Although a case has been explained with the present embodiment where the imaging apparatus is a home video camera, the present invention is applicable to any apparatus as long as it is an electronic device having an imaging apparatus that images an optical image of a subject. For example, the present invention is naturally applicable to digital cameras and commercial video cameras and is also applicable to mobile telephones with cameras, mobile information terminals such as PDA (personal digital assistant) and information processing apparatuses such as personal computers having imaging apparatuses.

Further, with the present embodiment, although display screen 200 is a liquid crystal monitor provided on the lateral side of a home video camera, the present invention is not limited to this and is applicable to a liquid crystal monitor forming an electronic view finder. In addition, similar to the above embodiment, the present invention is applicable to display screens provided in imaging apparatuses other than video cameras.

Further, various display methods in the present embodiment are only examples and can be substituted by various display methods. For example, although the width of the frame encompassing main subject 300 is changed with the example of FIG. 8, the state of tracking processing may be reported to the user by changing the flashing interval of the frame or the color of the frame. Further, numerical values that are used to determine the width or flashing interval of the frame may be displayed on display screen 200. This frame display is not essential and display of an arrow for example is substitutable.

Further, the various states of tracking processing explained above may be presented to the user using combinations of a plurality of states of tracking processing. By so doing, it is possible to acquire respective advantages in synergy.

Further, although the moving speed of the subject is calculated using the motion vector with the present embodiment, the present invention is not limited to this and the moving speed of the subject may be detected using a separate, external sensor.

Further, although the present embodiment is configured by providing tracking shooting mode for designating the subject and displaying frame 210 in the center of display screen 200 upon tracking shooting mode to designate the main subject as the tracking target, the scope of the present invention is not limited to this. For example, a configuration is possible where display section 110 is a touch panel liquid crystal monitor and a certain rectangular area based on the coordinate touched on the touch panel liquid crystal monitor may be decided as the main subject of the tracking target. Further, a configuration may be possible where subject storing mode which is directed to storing the features of the main subject is provided, the main subject of the tracking target is designated by displaying frame 210 in the center of display screen 200 upon this mode, and then one of a plurality of main subjects that are stored in subject storing mode and that are the tracking targets can be selected when subject storing mode switches to tracking shooting mode.

Further, although the terms “imaging apparatus” and “imaging method” are used with the present embodiment for ease of explanation, the terms may be “photographing apparatus” or “digital camera” for “imaging apparatus” and “image displaying method” or “photographing aiding method” for “imaging method.”

Furthermore, components forming the above imaging apparatus, the type of the imaging optical system, the driving section for the imaging optical system, the method of attaching the imaging optical system and the type of the tracking processing section are not limited to the above embodiment.

A case has been explained with the present embodiment as an example where display information creating section 107 creates display information based on the resources (for example, tracking processing result history, and the motion vector and location information of the main subject) accumulated in system controlling section 108, according to a command from system controlling section 108, and system controlling section 108 superimposes display information created in display information creating section 107 upon video image data using the OSD function and controls display section 110 to display video image data. System controlling section 108 may have the function of above display information creating section 107 and display section 110 may have the OSD function. System controlling section 108 is formed in a microcomputer and display information creating section 107 is expressly shown as a block for carrying out display information creation processing in this microcomputer.

Accordingly, the above explained imaging apparatus can be implemented by a program for operating the imaging method of this imaging apparatus. This program is stored in a computer readable recording medium.

The imaging apparatus and imaging method according to the present invention display information showing the state of tracking processing, and, consequently, can make the user know in advance the possibility of failure or stop of tracking processing due to frame-out of the main subject for example, so that the imaging apparatus and imaging method increase the effectiveness of the function of tracking the subject and are useful for various imaging apparatuses with tracking functions and imaging methods such as digital cameras and digital video cameras.

What is claimed is:

1. An imaging apparatus comprising:
an imaging optical system that forms an optical image of a subject;
an imaging section that converts the optical image into an electrical signal;
a signal processing section that carries out predetermined processing of the electrical signal to generate image data;
a display section that displays the generated image data on a display screen;
a tracking section that tracks the subject which is designated at random, based on the generated image data;
a display information creating section that creates display information showing a state of the subject that is being tracked, based on at least one of a motion of the subject that is being tracked in the display screen and a location of the subject that is being tracked in the display screen; and
a controlling section that displays the created display information in the display section.

2. The imaging apparatus according to claim 1, wherein the display information comprises information for calling for an attention of a user to prevent the user from losing a sight of the subject that is being tracked.

3. The imaging apparatus according to claim 1, wherein the display information comprises information for calling for an attention of a user to prevent the subject that is being tracked from going out of a frame in the display screen.

4. The imaging apparatus according to claim 1, wherein the display information comprises location change information showing a change in the location of the subject that is being tracked.

5. The imaging apparatus according to claim 4, further comprising a movement amount detecting section that detects an amount of movement of the imaging apparatus,
wherein the display information creating section adds the amount of movement of the imaging apparatus detected by the movement amount detecting section, to the location change information.

6. The imaging apparatus according to claim 1, wherein the display information comprises information showing a motion vector of the subject that is being tracked.

7. The imaging apparatus according to claim 1, wherein the display information comprises information including a direction toward which the subject that is being tracked is likely to go out of a frame in the display screen.

8. The imaging apparatus according to claim 1, wherein the display information comprises information highlighting a direction toward which the subject that is being tracked is likely to go out of a frame in the display screen.

9. The imaging apparatus according to claim 1, wherein the display information comprises information showing how far the location of the subject that is being tracked is from a center of the display screen.

10. The imaging apparatus according to claim 1, wherein the display information includes distances from four of upper, lower, left and right sides of the display screen, to the location of the subject that is being tracked.

11. The imaging apparatus according to claim 1, wherein the display information includes a trajectory as history of a tracking result in the tracking section.

12. The imaging apparatus according to claim 1, wherein the display information includes a warning message.

13. The imaging apparatus according to claim 1, wherein the controlling section superimposes the display information created in the display information creating section upon the subject that is being tracked to display in the display section.

14. The imaging apparatus according to claim 1, wherein the controlling section superimposes the display information created in the display information creating section upon the image data created in the signal processing section using an on screen display function.

15. An imaging method in an imaging apparatus comprising:
tracking a subject that is designated at random from image data shot by the imaging apparatus;
creating display information showing a state of the subject that is being tracked, based on at least one of a motion of the subject that is being tracked in a predetermined display screen and a location of the subject that is being tracked in the display screen; and
displaying the created display information.
